(19) United States
(12) Patent Application Publication
(10) Pub. No.: US 2025/0086693 A1
(43) Pub. Date: Mar. 13, 2025

(54) INFORMATION PROCESSING SYSTEM, INFORMATION PROCESSING METHOD, AND INFORMATION PROCESSING PROGRAM

(71) Applicant: SuperSanshi Co., Ltd., Yokkaichi-shi (JP)

(72) Inventor: Mamoru Takakura, Yokkaichi-shi (JP)

(21) Appl. No.: 18/963,099

(22) Filed: Nov. 27, 2024

Related U.S. Application Data
(63) Continuation of application No. PCT/JP2024/020497, filed on Jun. 5, 2024.

(30) Foreign Application Priority Data
Jun. 6, 2023 (JP) 2023-093045
Jul. 14, 2023 (JP) 2023-116003

(51) Int. Cl. G06Q 30/0601

(52) U.S. Cl. CPC G06Q 30/0635

(57) ABSTRACT

An information processing system comprises: a storage unit that stores a user's purchase state of a product; and a management unit that manages the purchase state, and when information on the product for the user is read at a store, stores the purchase state of the product in the storage unit with the purchase state set to an unpurchased state, wherein the management unit determines whether or not a first condition has been satisfied after the product has been set to the unpurchased state, and when it is determined that the first condition has been satisfied, updates the purchase state of the product stored in the storage unit from the unpurchased state to a purchased state.

### CROSS-REFERENCE TO RELATED APPLICATIONS

This application is a continuation of and claims priority to the International Patent Application PCT/JP2024/020497 filed on Jun. 5, 2024 which claims the benefit of priority to Japanese Patent Application No. 2023-093045 filed on Jun. 6, 2023 and Japanese Patent Application No. 2023-116003 filed on Jul. 14, 2023. The entire contents of each of the foregoing is incorporated herein by reference in their entireties.

### TECHNICAL FIELD

The present disclosure relates to an information processing system, an information processing method, and an information processing program.

### BACKGROUND

Conventionally, there have been provided various home delivery services in which products purchased by a user at a retail store (e.g., a convenience store, a supermarket, or an online supermarket) are delivered to the user's home (e.g., Japanese Patent No. 6456545).

### SUMMARY

In conventional home delivery services such as those described above, there is room for improvement in terms of the convenience for users when purchasing products.

Therefore, one of the objects of the present disclosure is to provide an information processing system, an information processing method, and an information processing program that can improve the convenience for users.

An information processing system according to one aspect of the present disclosure comprises: a storage unit that stores a user's purchase state of a product; and a management unit that manages the purchase state, and when information on the product for the user is read at a store, stores the purchase state of the product in the storage unit with the purchase state set to an unpurchased state, wherein the management unit determines whether or not a first condition has been satisfied after the product has been set to the unpurchased state, and when it is determined that the first condition has been satisfied, updates the purchase state of the product stored in the storage unit from the unpurchased state to a purchased state.

In an information processing method according to another aspect of the present disclosure, one or more information processing apparatuses perform: a step of storing a user's purchase state of a product; a step of, when information on the product for the user is read at a store, setting the purchase state of the product to an unpurchased state; a step of determining whether or not a first condition has been satisfied after the product has been set to the unpurchased state; and a step of, when it is determined that the first condition has been satisfied, updating the purchase state of the product from the unpurchased state to a purchased state.

In an information processing program according to another aspect of the present disclosure, one or more information processing apparatuses are caused to perform as: a storage unit that stores a user's purchase state of a product; and a management unit that manages the purchase state, and when information on the product for the user is read at a store, stores the purchase state of the product in the storage unit with the purchase state set to an unpurchased state, wherein the management unit determines whether or not a first condition has been satisfied after the product has been set to the unpurchased state, and when it is determined that the first condition has been satisfied, updates the purchase state of the product stored in the storage unit from the unpurchased state to a purchased state.

### DESCRIPTION OF DRAWINGS

FIG. 1 is a conceptual diagram of home storage using an information processing system according to a first embodiment.

FIG. 2 is a diagram showing an example of a schematic configuration of the information processing system according to the first embodiment.

FIG. 3 is a diagram showing an example of a hardware configuration of each information processing apparatus according to the first embodiment.

FIG. 4 is a diagram showing an example of configurations of a server 10, a user terminal 20, and a store terminal 30 according to the first embodiment.

FIG. 5 is a diagram showing an example of the price of a product according to the first embodiment.

FIG. 6 is a diagram showing an example of a purchase state according to the first embodiment.

FIG. 7 is a diagram showing an example of purchase history information according to the first embodiment.

FIG. 8 is a diagram showing an example of a display screen for product information according to the first embodiment.

FIG. 9 is a diagram showing an example of operation of the server 10, the user terminal 20, and the store terminal 30 according to the first embodiment.

FIG. 10 is a diagram showing an example of operation of the server 10, the user terminal 20, and the store terminal 30 according to a second embodiment.

### DETAILED DESCRIPTION

Embodiments of the present disclosure will be described with reference to the accompanying drawings. Note that in each figure, those with the same reference numeral have the same or similar configuration.

### First Embodiment

### (Overview)

An information processing system according to this embodiment stores information on the selling price of a product at a store (hereinafter also referred to as “price information”). The price information may be collected and stored from master data of POS (Point of Sales: point-of-sales information management system) or the like. As the price information, a discount price lower than the regular price of the product may be stored in association with a period during which the discount price is applied to the product (hereinafter referred to as “applicable period”). The information processing apparatus receives an instruction to purchase a product, and determines the purchase price of the product at the lowest selling price of the product in a predetermined period with reference to predetermined timing related to the purchase of the product (hereinafter referred to as “purchase timing”). This makes it possible to provide the product to the user at a reasonable price at any time regardless of the timing when the user needs it.

The method of determining the purchase price of a product in the information processing system according to this embodiment can be used, for example, when the product is purchased at a store. The store may be a store that really exists at a predetermined location, or may be a virtual store such as a store on the Web. The purchase price determination method can also be used in a delivery service that delivers a product purchased at a store to a delivery destination (e.g., a user's home). In this case, an instruction to purchase a product may be received from a terminal provided in the store (e.g., a POS register terminal), or may be received from the user's terminal (e.g., the user's smartphone).

The method of determining the purchase price of a product in the information processing system according to this embodiment can also be applied to “home storage”. Home storage is a service in which a user is allowed to store one or more products delivered to the user's home while the products are still in a state of not being purchased (hereinafter referred to as “unpurchased state”) and a product will be regarded as purchased when, for example, it is selected by the user from among the products. Note that home delivery refers to delivering a product to a place where a user can store the product (e.g., inside the house or in a dedicated locker installed next to the house).

In conventional home delivery services, a product purchased by a user is delivered to the user's home, and therefore when the user forgets to purchase products (e.g., products that are used on a daily basis but do not run out frequently and therefore forgotten to purchased, such as soy sauce or rice) or when products that are not usually needed (e.g., alcohol, snacks, etc. for unexpected visitors) are suddenly needed, there is a risk that the products cannot be provided in a timely manner. On the other hand, in home storage, products are delivered to a user's home while still in the unpurchased state and the products are stored by the user for a predetermined period, and therefore the user can purchase necessary products when they become necessary from among the products stored by themselves and use the products. Therefore, products can be provided to a user in a timely manner. Hereinafter, a product delivered to a user's home while still in the unpurchased state and stored by the user will be referred to as “home-stored product”. When a “product” is referred to in the following, the product is not limited to a home-stored product but may be a product other than home-stored products.

Hereinafter, an example will be described in which the method of determining the purchase price of a product in the information processing system according to this embodiment is applied to home storage described later, but as described above, the purchase price determination method can of course be applied to those other than home storage.

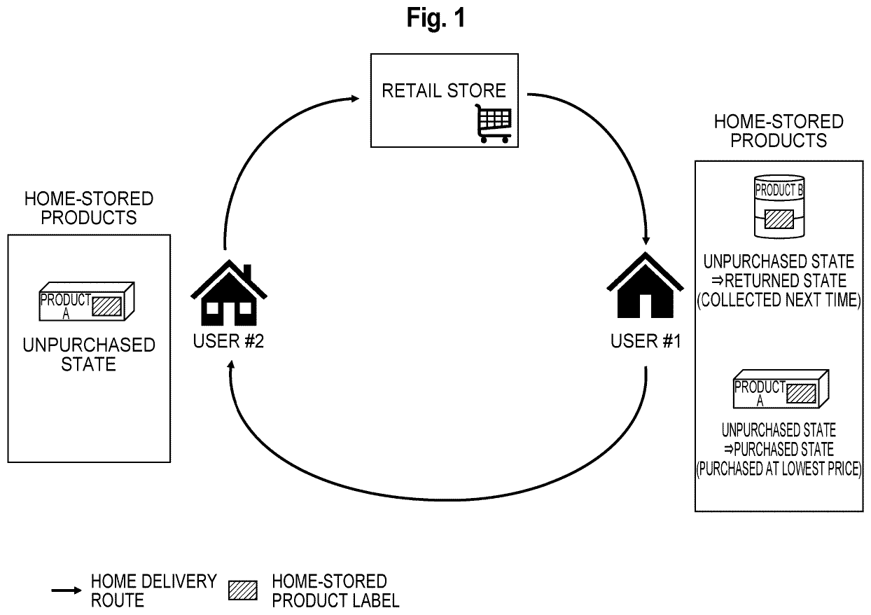

FIG. 1 is a conceptual diagram of home storage using the information processing system according to this embodiment. In home storage, the purchase states of home-stored products are managed. The purchase state includes, for example, at least the unpurchased state described above and a state in which an instruction to purchase a home-stored product from a user has been received (hereinafter referred to as “purchased state”). In addition to the unpurchased state and the purchased state, the purchase state may include a state in which an instruction to return a home-stored product from a user has been received (hereinafter referred to as “returned state”). “Purchase registration” in home storage refers to updating the purchase state of a home-stored product from the unpurchased state to the purchased state when a predetermined condition is satisfied, for example, it may refer to updating the purchase state of a home-stored product from the unpurchased state to the purchased state when an instruction to purchase the home-stored product has been received. “Return registration” may refer to updating the purchase state of a home-stored product from the unpurchased state to the returned state when an instruction to return the home-stored product has been received.

For example, in FIG. 1, home-stored products A and B for a user #1 are delivered from a retail store to the user #1's home with the purchase state remaining the unpurchased state, and stored by the user #1 for a predetermined period. Similarly, a home-stored product A for a user #2 is delivered from the retail store to the user #2's home with the purchase state remaining the unpurchased state, and stored by the user #2 for a predetermined period. Note that the home-stored products of each user may be determined based on at least one of information on purchase history of each user (hereinafter referred to as “purchase history information”) and an order instruction from each user. The order instruction may be an instruction to order a product desired by each user, or may be an order instruction for the product and its quantity. Information on the determined home-stored products (hereinafter referred to as “product information”) may be output to each user and a clerk of the store or a home delivery person for the home-stored products.

As the home delivery route of the home-stored products for the users #1 and #2, for example, a home delivery route in an existing home delivery service may be used. The date and/or time (hereinafter referred to as “date and time”) when the home-stored products are delivered to the homes of the users #1 and #2 may be, for example, a date and time of home delivery in an existing home delivery service, or a date and time or a day of the week (e.g., Thursday) when the frequency of use of the existing home delivery service is relatively low. A home-stored product may be given information indicative of being the home-stored product (e.g., a home-stored product label in FIG. 1). Thereby, even when products for the existing home delivery service and the home-stored products are delivered to the home on the same date and time, the user can easily distinguish between them.

For example, in FIG. 1, when the user #1 needs the home-stored product A among the home-stored products A and B, an instruction to purchase the home-stored product A from the user #1 is received. In response to the purchase instruction, purchase registration is performed to update the purchase state of the home-stored product A from the unpurchased state to the purchased state.

Note that for a home-stored product, the payment process for the product may be performed after the purchase state is updated to the purchased state. As the settlement means for the home-stored product A, for example, a predetermined direct debit by monthly deferred payment is conceivable, but without limitation thereto, it is sufficient that various settlement means are used. The payment process for the product may be performed on a server 10 or may be performed outside the information processing system 1.

The home delivery fee for home-stored products may be determined based on the purchase prices of other products (e.g., products at a retail store or products in an existing home delivery service) and the purchase prices of the home-stored products. For example, the home delivery fee for the home-stored products for the user #1 may be determined to be free if the sum of the purchase price of the product A, which is a home-stored product, and the purchase prices of other products is equal to or more than a predetermined value or is more than the predetermined value.

In FIG. 1, when an instruction to return the home-stored product B from the user #1 is received, return registration is performed to update the purchase state of the home-stored product B from the unpurchased state to the returned state. In this case, the home-stored product B may be collected from the user #1 by a store clerk or a home delivery person on the next delivery date to the user #1 and returned to the retail store.

In FIG. 1, the home-stored products may be delivered to the homes of the users #1 and #2 after it is confirmed at the store that the users #1 and #2 are at home. Specifically, the presence-at-home state of each user may be determined based on information on the location of each user (hereinafter referred to as “location information”), and information on the determined presence-at-home state (hereinafter referred to as “presence-at-home information”) may be notified to the store. A store clerk or a home delivery person may deliver home-stored products to the home of a user with the presence-at-home information indicating that they are at home so that the home-stored products can be delivered by hand.

### (Configuration)

Next, a configuration of the information processing system according to this embodiment will be described. Various services described in this embodiment are provided by one or more information processing apparatuses constituting the information processing system.

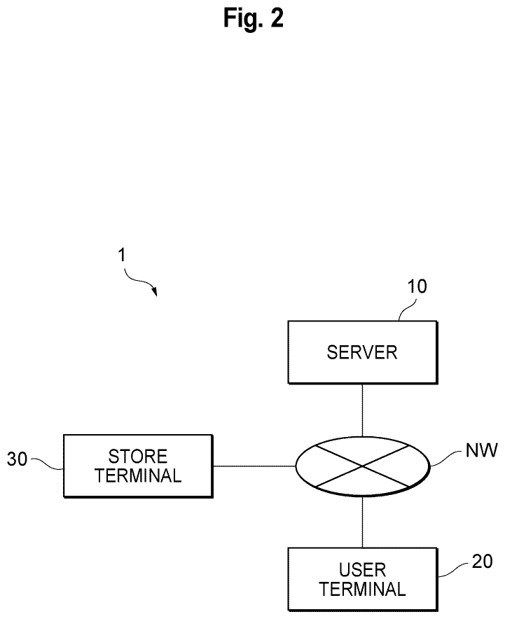

FIG. 2 is a diagram showing an example of a schematic configuration of the information processing system according to this embodiment. As shown in FIG. 2, the information processing system 1 includes a server 10, a user terminal 20, a store terminal 30, and a network that connects at least two of the server 10, the user terminal 20, and the store terminal 30. The one or more information processing apparatuses according to this embodiment may be the server 10, may be the user terminal 20, may be the store terminal 30, or may be at least two of the server 10, the user terminal 20, and the store terminal 30.

The server 10 is a server that manages products and may be configured to include one or more information processing apparatuses. The user terminal 20 is an information processing apparatus used by a user, such as a smartphone, a tablet, or a personal computer. The store terminal 30 is an information processing apparatus used by a clerk of a retail store or a home delivery person, such as a smartphone, a tablet, or a personal computer. The network NW is a wired and/or wireless network, and may include, for example, the Internet and/or an intranet. Note that although one user terminal 20 is shown in FIG. 2, the user terminal 20 may of course be provided for each user.

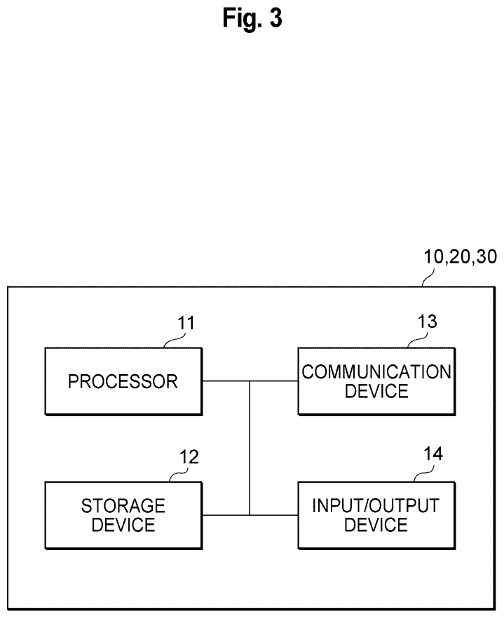

FIG. 3 is a diagram showing an example of a hardware configuration of each information processing apparatus according to this embodiment. As shown in FIG. 3, each information processing apparatus includes a processor 11 such as a CPU (Central Processing Unit) corresponding to an arithmetic unit, a storage device 12, a communication device 13, and an input/output device 14. These components are connected to each other via a bus so as to be able to transmit and receive data among them.

The processor 11 is, for example, a CPU (Central Processing Unit), and is a device that performs control related to the execution of a program stored in the storage device 12 and operation or processing of data. The processor 11 receives various input data from the input/output device 14 and/or the communication device 13, and outputs (e.g., displays) the operation results for the input data to the input/output device 14, stores them in the storage device 12, or transmits them via the communication device 13. The processor 11 may be referred to as “control unit” or the like.

The storage device 12 is at least one of a memory, an HDD (Hard Disk Drive), and an SSD (Solid State Drive). The storage device 12 may be referred to as “storage unit” or the like.

The communication device 13 is a device that performs communication via a wired and/or wireless network, and may include, for example, a network card, a communication module, a chip, an antenna, a GPS (Global Positioning System) sensor, and the like. The communication device 13 may be referred to as “transmission unit”, “receiving unit” and/or the like.

The input/output device 14 includes an input device such as a keyboard, a touch panel, a mouse and/or a microphone, and an output device such as a display and/or a speaker. The input/output device may be referred to as, for example, at least one of “input unit”, “output unit” and “display unit”.

The hardware configuration described above is merely an example. In each information processing apparatus, a part of the hardware shown in FIG. 3 may be omitted, or hardware not shown in FIG. 3 may be provided. The hardware shown in FIG. 3 may be composed of one or more chips. When the information processing apparatus is composed of a plurality of devices, each device may include at least some of these pieces of hardware.

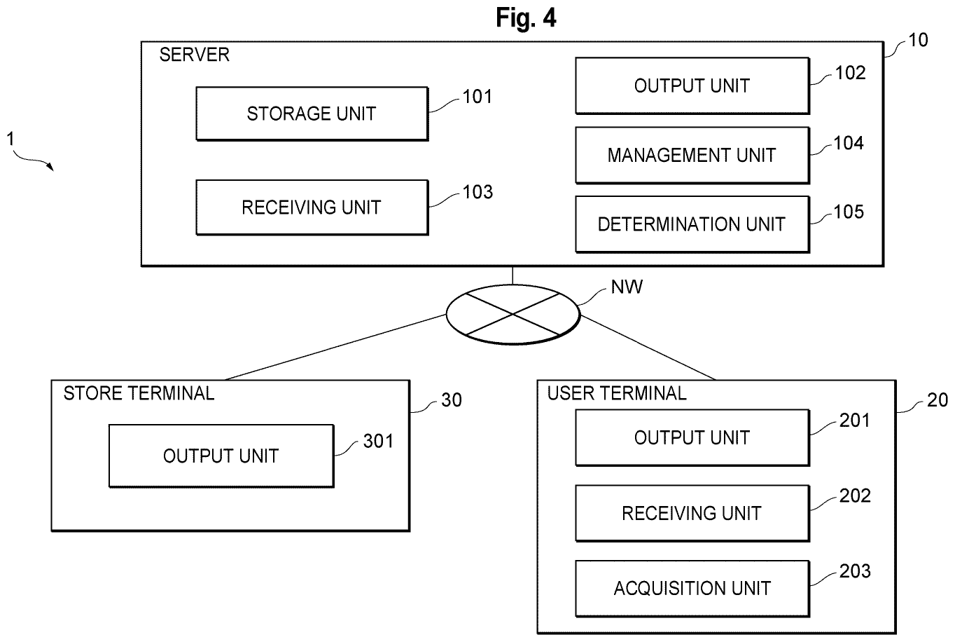

FIG. 4 is a diagram showing functional configurations of the server 10, the user terminal 20, and the store terminal 30 according to this embodiment. As shown in FIG. 4, the server 10 includes a storage unit 101, an output unit 102, a receiving unit 103, a management unit 104, and a determination unit 105. The storage unit 101 may be realized by the storage device 12. The output unit 102 and the receiving unit 103 may be realized by at least some of an information processing program executed by the processor 11 of the server 10 and the communication device 13 of the server 10. The management unit 104 and the determination unit 105 may be realized by an information processing program executed by the processor 11. Note that the information processing program may be stored in the storage device 12 of the server 10 or a recording medium. The server 10 may of course include components not shown.

The storage unit 101 stores price information. Specifically, the storage unit 101 may store the history or transition of price information. For example, the storage unit 101 may collect price information on a daily basis from POS master data or the like, and store the date and the price information in association with each other for each product. The storage unit 101 may store a discount price that is lower than the regular price of a product in association with the applicable period during which the discount price is applied to the product. The storage unit 101 may also store the regular price of a product in association with the applicable period during which the regular price is applied to the product.

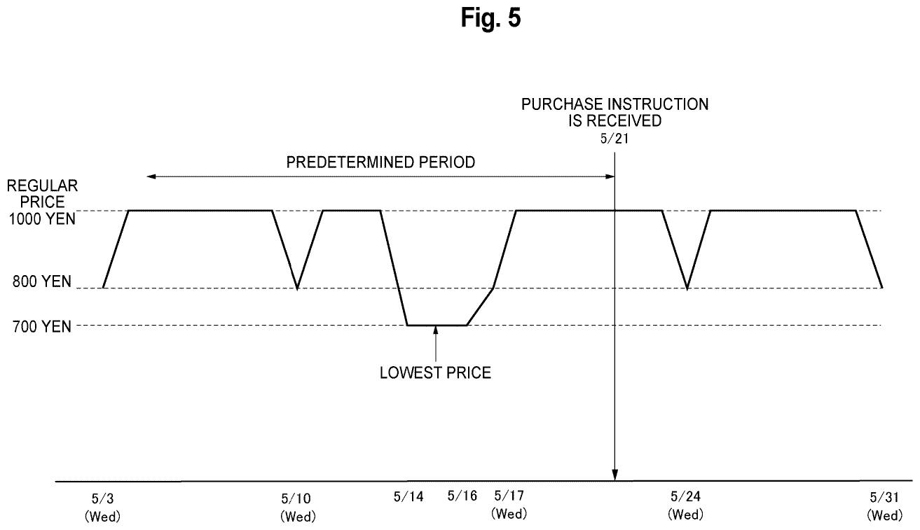

FIG. 5 is a diagram showing an example of the selling price of a product according to this embodiment. For example, in FIG. 5, the regular price of a product is 1000 yen, and a discount price of 800 yen is applied every Wednesday, and a discount price of 700 yen is applied on May 14 to 16. The storage unit 101 may store the discount price of 800 yen of the specific product and each of the applicable periods of “May 3 (Wednesday)”, “May 10 (Wednesday)”, “May 17 (Wednesday)” and “May 24 (Wednesday)” during which the discount price is applied in association with each other, and store the discount price of 700 yen and the applicable period of “May 14 to 16” during which the discount price is applied in association with each other. The storage unit 101 may store the regular price of 1000 yen and each of the applicable periods of “May 4 to 9”, “May 11 to 13”, “May 18 to 23”, and “May 25 to 30” during which the regular price is applied in association with each other. Note that in FIG. 5, the applicable periods are shown in days, but without being limited thereto, they may be in hours.

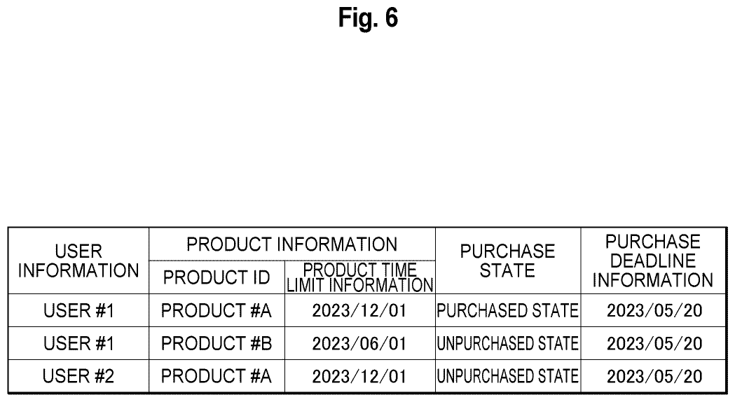

The storage unit 101 may store the state of purchase of a home-stored product by a user. FIG. 6 is a diagram showing an example of the purchase state according to this embodiment. As shown in FIG. 6, the state of purchase of a home-stored product by a user may be stored in association with the product information for the home-stored product, information on the user (hereinafter referred to as “user information”), and information on the purchase deadline (hereinafter referred to as “purchase deadline information”). For example, in FIG. 6, the unpurchased state and the purchased state are shown as the purchase state, but without limitation thereto, other states such as the returned state may be included. The user information may include, for example, at least one of the user's identifier, name, address, and the like.

The product information may include, for example, at least one of a product ID that is an identifier of the product, information on the product time limit of the product (hereinafter referred to as “product time limit information”), the product name, its quantity not shown, and the like. The product time limit is, for example, at least one of the use-by date and the best-before date, and the product time limit information may be any information indicating the product time limit. The purchase deadline information is information on the deadline for purchase of the home-stored product by the user, for example, it may be a predetermined period after the home delivery date and time, or may be a date and time that is a predetermined period before the product time limit.

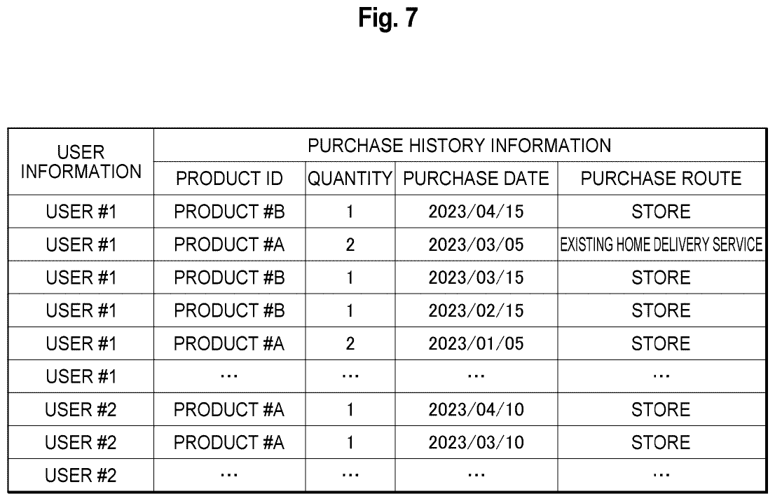

The storage unit 101 may store purchase history information for a history of purchase of products by a user. FIG. 7 is a diagram showing an example of purchase history information according to this embodiment. As shown in FIG. 7, the storage unit 101 may store the purchase history information of users in association with the user information described above. The purchase history information may include at least one of, for example, a product ID that is an identifier of a product, information on the quantity of the product purchased, information on the purchase date, information on the purchase route (e.g., a store, an existing home delivery service, or home storage). Note that “STORE” listed as the purchase route in FIG. 7 indicates that the product has been purchased using a cash register of the store. The storage unit 101 may be composed of a plurality of storage means that are physically or logically different. For example, the price information may be stored in a first storage unit, the purchase state may be stored in a second storage unit, and the purchase history information may be stored in a third storage unit. The price information, the purchase state, and the purchase history information may be stored in a storage unit external to the information processing system 1.

The output unit 102 outputs information on the purchase price determined by the determination unit 105 described later (hereinafter referred to as “purchase price information”). The output unit 102 may output the purchase price to the user or may output it at the store. For example, the output unit 102 may transmit the purchase price information to the user terminal 20 of the user or the store terminal 30 via the communication device 13 (the transmission unit) of the server 10.

The output unit 102 may output the product information for home-stored products to a user. For example, the output unit 102 may transmit the product information to the user terminal 20 of the user via the communication device 13 (the transmission unit) of the server 10.

The output unit 102 may output the product information for home-stored products to a store clerk or a home delivery person for the home-stored products. For example, the output unit 102 may transmit the product information determined by the management unit 104 to the store terminal 30 of the store via the communication device 13 (the transmission unit) of the server 10. The output unit 102 may output the presence-at-home information for the presence-at-home state of the user to the store. For example, the output unit 102 may transmit the presence-at-home information determined by the management unit 104 to the store terminal 30 of the store via the communication device 13 (the transmission unit) of the server 10. The output unit 102 may output information on home-stored products for which purchase registration or return registration has been performed by the management unit 104 to a clerk of the store or a home delivery person. For example, the output unit 102 may transmit the information on the home-stored products for which purchase registration or return registration has been performed to the store terminal 30 of the store via the communication device 13 (the transmission unit) of the server 10.

The output unit 102 may output a message to the user about a product for which the time limit indicated by the time limit information stored in the storage unit 101 satisfies a predetermined condition. For example, the output unit 102 may transmit the message to the user terminal 20 of the user via the communication device 13 (the transmission unit) of the server 10.

The receiving unit 103 receives an instruction to purchase a home-stored product selected by a user within a predetermined period among the home-stored products indicated by the product information output to the user by the output unit 102. For example, the receiving unit 103 may receive information on the purchase instruction input by the user to the user terminal 20 via the communication device 13 (the receiving unit) of the server 10. The information on the purchase instruction may include the product for which the purchase instruction has been received and the quantity of the product.

The receiving unit 103 may receive an instruction to return or purchase a home-stored product from a user. Specifically, the receiving unit 103 may receive the instruction to return or purchase the home-stored product from the user in response to a message output to the user by the output unit 102. For example, the receiving unit 103 may receive information on the return instruction or the purchase instruction that is input by the user to the user terminal 20 via the communication device 13 (the receiving unit) of the server 10. The information on the return instruction or the purchase instruction may include the product for which the return instruction or the purchase instruction has been received and the quantity of the product.

The receiving unit 103 may receive an instruction to order a product from the user. The receiving unit 103 may receive an order instruction for the quantity of a product from the user. Specifically, the receiving unit 103 may receive information on the order instruction (e.g., the product and/or the quantity of the product) that is input by the user to the user terminal 20 via the communication device 13 (the receiving unit) of the server 10.

The receiving unit 103 may receive an instruction to change the purchase deadline stored in the storage unit 101. The instruction to change the purchase deadline may be, for example, input by an administrator to the store terminal 30 or a terminal of the management company of the retail store.

The management unit 104 manages the purchase states of the home-stored products. Specifically, the management unit 104 determines whether or not a home-stored product delivered to a user's home with the purchased state set to the unpurchased state satisfies a predetermined condition (a first condition). Then, when it is determined that the first condition is satisfied, the management unit 104 performs purchase registration by updating the purchase state of the home-stored product stored in the storage unit 101 from the unpurchased state to the purchased state. As the first condition, various conditions may be set in advance. For example, a condition related to an instruction to purchase a home-stored product from a user may be used as the first condition. For example, when an instruction to purchase the product A of the home-stored products of the user #1 is received by the receiving unit 103, the purchase state of the product #A of the home-stored products of the user #1 is updated to the purchased state as shown in FIG. 5.

A condition related to an instruction to order a product from a user may be used as the first condition. At this time, the reception of an order instruction for the same product as a home-stored product with the purchase state set to the unpurchased state may be used as the condition. Regardless of home storage or normal home delivery, the reception of an instruction to order the product may be used as the condition. For example, when an order instruction is received by the receiving unit 103 for the same product as a home-stored product with the purchase state set to the unpurchased state, the management unit 104 may update the purchase state of the home-stored product stored in the storage unit 101 from the unpurchased state to the purchased state.

A condition related to the purchase deadline for a product may be used as the first condition. For a home-stored product whose purchase state is the unpurchased state and for which the purchase deadline has been exceeded, the management unit 104 may update the purchase state stored in the storage unit 101 from the unpurchased state to the purchased state. When an instruction to change the purchase deadline is received by the receiving unit 103, the management unit 104 may update the purchase deadline stored in the storage unit 101 based on the change instruction.

A condition related to the product time limit of a product may be used as the first condition. For a home-stored product whose purchase state is the unpurchased state and for which the period until the product time limit satisfies a predetermined condition (a second condition), the management unit 104 may update the purchase state stored in the storage unit 101 from the unpurchased state to the purchased state. For example, the predetermined condition (the second condition) may be that the remaining period until the product time limit is equal to or less than a predetermined period or is less than the predetermined period.

The management unit 104 determines the home-stored products indicated by the product information output to the user by the output unit 102 (i.e., the home-stored products). Specifically, the management unit 104 may determine the home-stored products based on at least one of the purchase history information for the user's product purchase history and an order instruction received by the receiving unit 103.

For example, the management unit 104 may input the user's purchase history information to the model stored in the storage unit 101 to determine the products recommended by the model as the home-stored products for the user. Note that the model may be generated based on machine learning using the purchase history information of each user and products recommended to each user as learning data. Alternatively, the management unit 104 may determine the same product as a home-stored product for which purchase registration has been performed as a home-stored product for the user regardless of whether or not an order instruction is received by the receiving unit 103 (i.e., the same product as a home-stored product for which purchase registration has been performed may automatically be ordered).

The management unit 104 may determine a product that satisfies a predetermined matching condition from among the plurality of products included in the purchase history information as a home-stored product delivered to the user with the purchase state set to the unpurchased state. The predetermined matching condition is, for example, a condition that the user has made a selection from the plurality of products included in the purchase history information. The predetermined matching condition is, for example, a condition that the product has the highest priority when the plurality of products included in the purchase history information are sorted according to a predetermined sorting condition. The predetermined sorting condition is a condition that the plurality of products included in a plurality of purchase histories are sorted in descending order of the number of past purchases of the user.

For a home-stored product for which the return instruction has been received by the receiving unit 103, the management unit 104 may perform return registration by updating the purchase state stored in the storage unit 101 from the unpurchased state to the returned state.

If the product time limit or the purchase deadline for a home-stored product for which the purchase instruction has not been received by the receiving unit 103 (i.e., a home-stored product in the unpurchased state) satisfies a predetermined condition, the management unit 104 may generate a message prompting a response for the home-stored product and output it from the output unit 102. The predetermined condition may be, for example, that the remaining period until the product time limit (e.g., the best-before date or the use-by date) or the purchase deadline is equal to or less than a predetermined period or is less than the predetermined period.

The management unit 104 may determine the home delivery fee for home-stored products. Specifically, the management unit 104 may determine it based on the purchase prices of other products (e.g., products at a retail store or products in an existing home delivery service) and the purchase prices of the home-stored products within a predetermined period. For example, if the sum of the purchase price of the product A, which is a home-stored product, and the purchase prices of other products is equal to or more than a predetermined value or is more than the predetermined value, the management unit 104 may determine the home delivery fee of the home-stored product for the user #1 to be free.

The management unit 104 may determine the presence-at-home state of the user based on the location information of the user terminal 20. For example, if the location information of the user terminal 20 is within a predetermined range from the user's address, the management unit 104 may determine that the presence-at-home state of the user indicates that they are at home.

The determination unit 105 determines the purchase price of a product. Specifically, the determination unit 105 determines the purchase price of the product at the lowest selling price of the product in a predetermined period with reference to the purchase timing of the product. If at least a part of the predetermined period with reference to the purchase timing of the product overlaps with applicable periods of discount prices, the determination unit 105 may determine the purchase price of the home-stored product at the lowest price of the discount prices applied to the overlapping applicable periods.

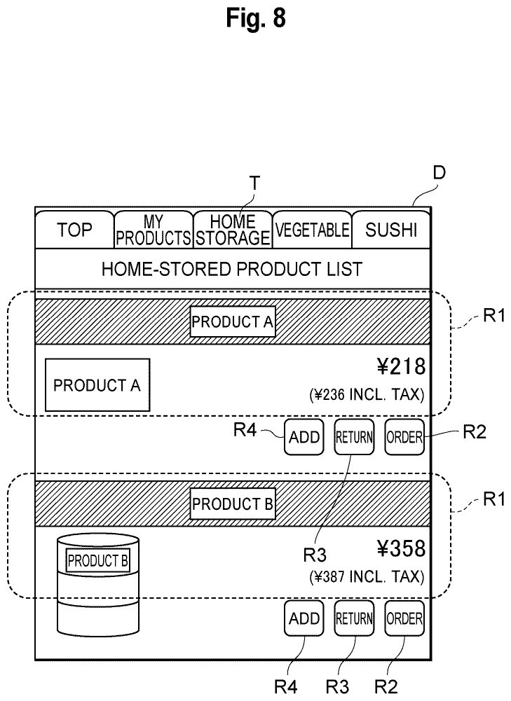

The purchase timing may be any timing related to the purchase of the product. For example, the purchase timing may be the timing when an instruction to purchase the home-stored product has been received by the receiving unit 103. Alternatively, the purchase timing may be the timing when payment processing is performed for the home-stored product for which the purchase instruction has been received (e.g., monthly or weekly timing). The purchase timing may be the timing when the purchase state of the home-stored product has been updated from the unpurchased state to the purchased state. The purchase timing may be the timing when an instruction to order the home-stored product has been received by the receiving unit 103. The purchase timing may be the timing when the home-stored product has been delivered to the user. The purchase timing may be the timing when the product information (e.g., FIG. 8) for the home-stored product is output to the user.

The predetermined period with reference to the purchase timing may be a predetermined period up to or before the purchase timing or before the purchase timing, a predetermined period from or after the purchase timing or after the purchase timing, or a continuous predetermined period including the purchase timing. Note that the predetermined period may be in days or hours.

For example, in FIG. 5, using the timing when an instruction to purchase the home-stored product has been received by the receiving unit 103 as the purchase timing, the determination unit 105 determines the purchase price of the home-stored product at the lowest price in a predetermined period with reference to the purchase timing. Specifically, in FIG. 5, since the instruction to purchase the home-stored product has been received by the receiving unit 103 on May 21, at least a part of the predetermined period with reference to May 21 overlaps with an applicable period of a discount price of 700 yen (May 14 to 16) and applicable periods of a discount price of 800 yen (May 10 (Wednesday) and May 17 (Wednesday)). The determination unit 105 may determine the purchase price of the home-stored product at the lowest price of 700 yen of the discount prices applied to the applicable periods overlapping with the predetermined period. Note that in FIG. 5, the purchase timing is shown in days, but without limitation thereto, it may be in hours.

The user terminal 20 includes an output unit 201, a receiving unit 202, and an acquisition unit 203. The output unit 201 may be realized by at least some of an information processing program executed by the processor 11 of the user terminal 20 and the communication device 13 and the input/output device 14 of the user terminal 20. The receiving unit 202 may be realized by at least some of the information processing program executed by the processor 11 of the user terminal 20 and the input/output device 14 of the user terminal 20. The acquisition unit 203 may be realized by at least some of the information processing program executed by the processor 11 of the user terminal 20 and the communication device 13 of the user terminal 20. Note that the information processing program may be stored in the storage device 12 of the user terminal 20 or a recording medium. The user terminal 20 may of course include components not shown.

The output unit 201 outputs product information from the server 10 to the user. For example, the output unit 201 may display the product information received from the server 10 by the communication device 13 (the receiving unit) of the user terminal 20 on the input/output device 14 (the display unit).

FIG. 8 is a diagram showing an example of a display screen for product information according to this embodiment. For example, as shown in FIG. 8, a display screen D may be provided with a region R1 showing product information (e.g., the product name and a product image) and price information for a home-stored product and regions R2, R3, and R4 for the user to input an instruction to purchase or return the home-stored product. The display screen D may be displayed when a home storage tab T is selected by the user. The display screen D may be provided with a region (not shown) for indicating the quantity in which a purchase instruction or a return instruction is given.

The prices of the products displayed on the display screen D (e.g., 218 yen for the product A and 358 yen for the product B) may be purchase prices determined by the determination unit 105 of the server 10. Alternatively, the prices of the products may be the prices of the product at the timing of displaying the display screen D. For example, if the timing of displaying the display screen D is within an applicable period of the regular price, the price of the product may be the regular price, and if the timing is within an applicable period of a discount price, the price of the product may be the discount price applied to the applicable period.

The output unit 201 may output a message from the server 10 to the user. For example, the output unit 201 may display a message received from the server 10 by the communication device 13 (the receiving unit) of the user terminal 20 on the input/output device 14 (the display unit) of the user terminal 20. As described above, the message may be output when the time limit for the home-stored product managed by the server 10 satisfies a predetermined condition.

The receiving unit 202 receives an instruction to purchase a home-stored product selected by the user within a predetermined period among the home-stored products indicated by the product information output to the user by the output unit 201. Specifically, the receiving unit 202 may receive purchase instruction information input by the user to the input/output device 14 (the input unit) of the user terminal 20, and transmit the purchase instruction information to the server 10 via the communication device 13 (the transmission unit) of the user terminal 20.

The receiving unit 202 may receive an instruction to return or purchase a product from the user in response to a message output to the user by the output unit 201. Specifically, the receiving unit 202 may receive information on the return instruction or the purchase instruction input by the user to the input/output device 14 (the input unit) of the user terminal 20 and transmit the information to the server 10 via the communication device 13 (the transmission unit) of the user terminal 20.

The receiving unit 202 may receive an instruction to order a product from the user. Specifically, the receiving unit 202 may receive information on the order instruction input by the user to the input/output device 14 (the input unit) of the user terminal 20 and transmit the information to the server 10 via the communication device 13 (the transmission unit) of the user terminal 20.

The acquisition unit 203 acquires the location information of the user terminal 20. The location information may be, for example, information acquired by a GPS sensor. The acquisition unit 203 may transmit the acquired location information to the server 10 via the communication device 13 (the transmission unit) of the user terminal 20.

The store terminal 30 includes an output unit 301. The output unit 301 may be realized by at least some of an information processing program executed by the processor 11 of the store terminal 30 and the communication device 13 and the input/output device 14 of the store terminal 30. Note that the information processing program may be stored in the storage device 12 of the store terminal 30 or a recording medium. The store terminal 30 may of course include components not shown.

The output unit 301 outputs product information from the server 10 to a store clerk or a home delivery person. For example, the output unit 301 may display product information received from the server 10 by the communication device 13 (the receiving unit) of the store terminal 30 on the input/output device 14 (the display unit).

The output unit 301 may output the presence-at-home information of the user to whom home-stored products are delivered to a store clerk or a home delivery person. For example, the output unit 301 may display product information received from the server 10 by the communication device 13 (the receiving unit) of the store terminal 30 on the input/output device 14 (the display unit).

The output unit 301 outputs purchase price information for a purchase price determined by the determination unit 105 of the server 10. For example, the output unit 301 may display purchase price information received from the server 10 by the communication device 13 (the receiving unit) of the store terminal 30 on the input/output device 14 (the display unit).

### (Operation)

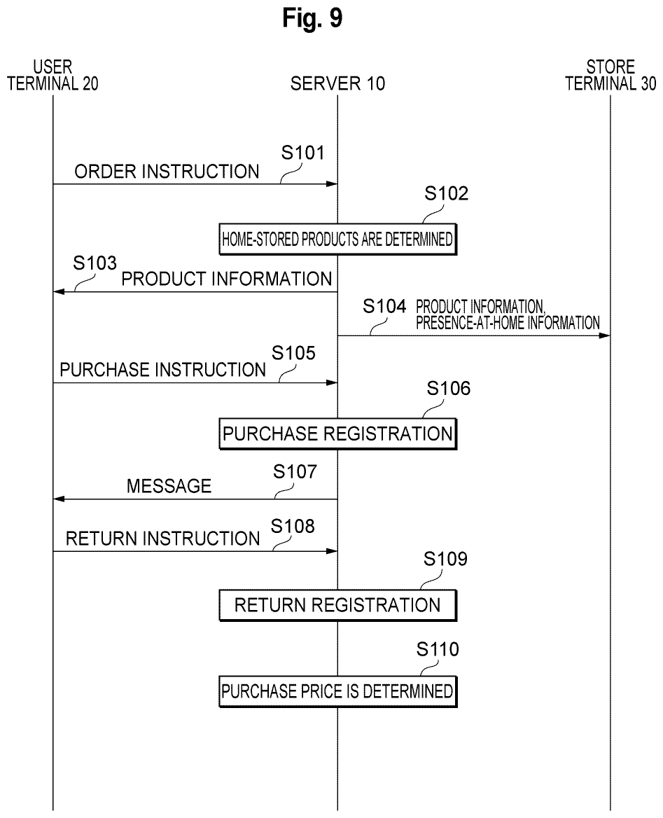

Next, operation of the information processing system according to this embodiment will be described. FIG. 9 is a diagram showing an example of operation of the server 10 and the user terminal 20 according to this embodiment. Note that FIG. 9 is for illustration only, and some steps (e.g., step S101 and/or S107-S109) may be omitted, steps not shown may be added, or orders of some steps (e.g., step S110) may be swapped.

In the step S101, the server 10 receives an instruction to order home-stored products from the user. For example, by receiving information on the order instruction input by the user to the user terminal 20 from the user terminal 20, the server 10 may receive the order instruction.

In step S102, the server 10 determines the home-stored products that are delivered to the user's home with the purchase state remaining the unpurchased state and are stored by the user for a predetermined period. For example, the server 10 may determine the home-stored products based on the order instruction received in step S101. The server 10 may determine the home-stored products based on the purchase history information of the user of the user terminal 20. The determination of the home-stored products based on the purchase history information may be performed using a predetermined model based on machine learning.

In step S103, the server 10 outputs the product information for the home-stored products determined in step S102 to the user. For example, the server 10 may transmit the product information to the user terminal 20, and the user terminal 20 may display the product information received from the server 10 (see, e.g., the display screen D shown in FIG. 7).

In step S104, the server 10 outputs the product information for the home-stored products determined in step S102 and the presence-at-home information to the store. A store clerk or a home delivery person delivers the home-stored products to the user based on these pieces of information. For example, the server 10 may transmit the product information to the store terminal 30, and the store terminal 30 may display the product information received from the server 10. This enables the store clerk or the home delivery person to recognize the home delivery products to be delivered to the user's home. The server 10 may transmit the presence-at-home information of the user to whom the home delivery products are delivered to the store terminal 30, and the store terminal 30 may display the store information received from the server 10. The store clerk or the home delivery person may deliver the home-stored products to the home of the user who is at home based on the presence-at-home information.

In step S105, the server 10 receives an instruction to purchase a home-stored product selected by the user within a predetermined period among the home-stored products indicated by the product information output to the user in step S103. Specifically, the user terminal 20 receives the purchase instruction input by the user and transmits information on the purchase instruction to the server 10. By receiving the information on the purchase instruction from the user terminal 20, the server 10 may receive the purchase instruction.

For example, as shown in FIG. 8, when the product information indicating the home-stored products A and B is displayed on the user terminal 20 of the user #1, the user #1 presses the region R2 of the home-stored product A. When detecting the press, the user terminal 20 of the user #1 transmits information on the instruction to purchase the home-stored product A to the server 10. By receiving the information on the purchase instruction from the user terminal 20, the server 10 may receive the instruction to purchase the home-stored product A.

In step S106, the server 10 performs the purchase registration of the home-stored product for which the purchase instruction has been received in step S105. Specifically, the server 10 may update the purchase state of the home-stored product from the unpurchased state to the purchased state. For example, as shown in FIGS. 1 and 6, the purchase state of the home-stored product A of the user #1 is updated from the unpurchased state to the purchased state by the purchase registration. Note that although not shown, information on the home-stored product A of the user #1 for which purchase registration has been performed may be transmitted to the store terminal 30. This enables the store clerk or the home delivery person to recognize that the user #1 has purchased the home-stored product A.

In step S107, if the product time limit or the purchase deadline for a home-stored product for which a purchase instruction has not been received in step S105 (i.e., a home-stored product in the unpurchased state) satisfies a predetermined condition, the server 10 outputs a message prompting a response to the home-stored product. Specifically, the server 10 may transmit the message to the user terminal 20, and the user terminal 20 may display the message received from the server 10. For example, as shown in FIG. 6, when the time limit information for the home-stored product B of the user #1 indicates Jun. 1, 2023 as the product time limit (e.g., the best-before date), there is less than one month left from the current time (e.g., May 8, 2023) before the product time limit expires, and therefore the server 10 may transmit a message prompting a response to the home-stored product B to the user terminal 20.

In step S108, the server 10 may receive an instruction to return the product from the user in response to the message output to the user in step S107. Specifically, the user terminal 20 receives the return instruction input by the user and transmits information on the return instruction to the server 10. By receiving the information on the return instruction from the user terminal 20, the server 10 may receive the return instruction. For example, when the region R3 of the display screen D1 shown in FIG. 8 is pressed by the user in response to the message output to the user, the user terminal 20 of the user #1, which has detected the press, transmits the information on the instruction to return the home-stored product B to the server 10. By receiving the information on the return instruction from the user terminal 20, the server 10 may receive the instruction to return the home-stored product A. Note that the timing of receiving the return instruction is not limited to the time of receiving the message in step S107, but may be the user's voluntary timing.

In step S109, the server 10 performs the return registration of the home-stored product for which the return instruction has been received in step S108. Specifically, the server 10 may update the purchase state of the home-stored product from the unpurchased state to the returned state. Note that although not shown, information on the home-stored product B of the user #1 for which return registration has been performed may be transmitted to the store terminal 30. For example, in the case shown in FIG. 1, if the home-stored product B of the user #1 is updated from the unpurchased state to the returned state, the store clerk or the home delivery person may collect the home-stored product B from the user #1 on the next delivery date to the user #1 based on the information notified from the server 10 to the store terminal 30.

Note that although a return instruction and return registration are shown in steps S108 and S109, there is no limitation to this. For example, if the user purchases the home-stored product in response to the message output to the user in step S107, then instead of steps S108 and S109, an instruction to purchase the home-stored product may be received in step S105 and the purchase registration in step S106 may be performed on the server 10. Even if there is no response from the user terminal 20 to the message, the server 10 may update the purchase state of the home-stored product from the unpurchased state to the purchased state if the purchase deadline has been exceeded. Similarly, even if there is no response, the purchase state of home-stored products for which the period until the product time limit satisfies a predetermined condition may be updated from the unpurchased state to the purchased state.

In step S110, the server 10 determines the purchase price of the home-stored product with the purchase state set to the purchased state (i.e., the home-stored product in the purchased state), and performs payment processing for the home-stored product with the user. Specifically, when at least a part of the predetermined period with reference to the purchase timing overlaps with applicable periods of discount prices, the server 10 may determine the purchase price of the home-stored product at the lowest price of the discount prices applied to the overlapping applicable periods. Note that the payment processing for products may be performed by, for example, a settlement system external to the information processing system 1.

As described above, in the information processing system according to this embodiment, home-stored products are delivered to a user's home while still in the unpurchased state and stored by the user for a predetermined period, and therefore the user can purchase a necessary product when necessary from the home-stored products and use the product. Therefore, since a product necessary for the user can be provided to the user in a timely manner, the convenience for the user can be improved. The purchase price of a home-stored product may be determined at the lowest price within a predetermined period with reference to the purchase timing, the home-stored product can be purchased at a reasonable price regardless of the timing when it is needed, and therefore the convenience for the user can be improved in this respect as well. Even if a purchase instruction from the user is not received, the purchase state of the home-stored product is updated from the unpurchased state to the purchased state when the predetermined first condition is satisfied, such as when the purchase deadline has been exceeded or when the period until the product time limit satisfies the predetermined condition (the second condition), and therefore it is possible to prevent omission of collection of the charge for the home-stored product.

### Second Embodiment

Next, an information processing system 1 of a second embodiment will be described. Hereinafter, the differences from the information processing system 1 of the first embodiment will be mainly described.

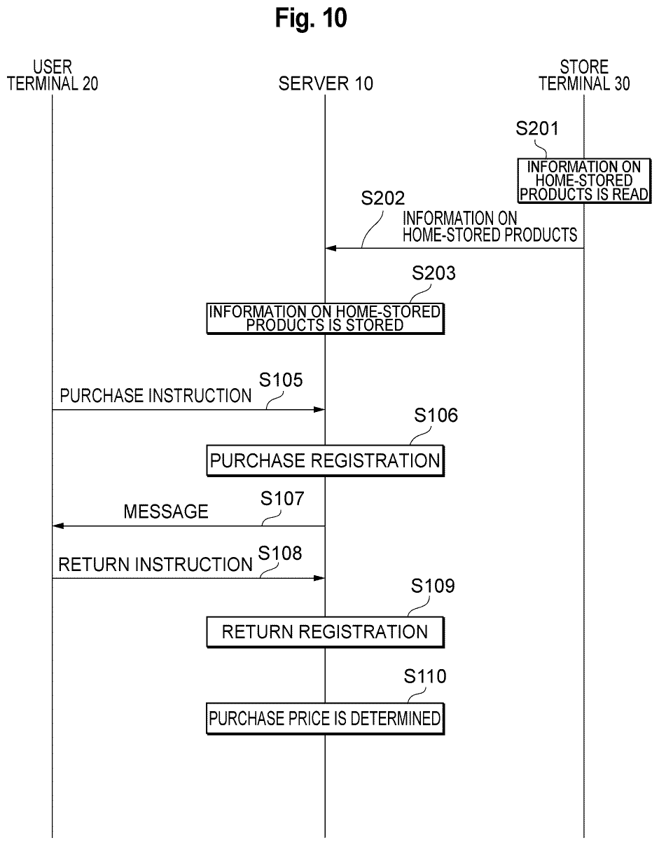

Instead of the method in which the server 10 delivers home-stored products to the user #1, the information processing system 1 of this embodiment employs a method in which the user #1 receives home-stored products at the store. Specifically, the information processing system 1 of this embodiment operates as shown in FIG. 10.

As shown in FIG. 10, in steps S201 and S202, after the user #1 selects a home-stored product, when information on the product such as the barcode of the product is read by the store terminal 30, the information on the home-stored product is transmitted to the server 10. The information on the home-stored product includes the product ID, the product time limit information, the purchase state, and the purchase expiration deadline information. The purchase state of the home-stored product at this time is set to the unpurchased state.

In step S203, the management unit 104 of the server 10 stores the information on the home-stored product transmitted from the store terminal 30 in the storage unit 101. That is, when the home-stored product is read at the store, the purchase information for the product is stored in the storage unit 101 while being set to the unpurchased state.

After step S203, the user #1 can take home the home-stored product in the unpurchased state. Thereafter, for example, the respective processes of steps S105-S110 are performed, and consequently the home-stored product is purchased by the user #1. Note that since the respective processes of steps S105-S110 shown in FIG. 10 are the same as or similar to the respective processes of steps S105-S110 shown in FIG. 9, detailed description of those processes is omitted.

As described above, in the information processing system 1 of this embodiment, when the information on the product of the user is read at the store, the management unit 104 of the server 10 stores the purchase state of the product in the storage unit 101 with the purchase state set to the unpurchased state. Note that when the user #1 has the home-stored product read at the store, it may be read by the user terminal 20, for example, on which an application for home storage is installed instead of having the information on the product read by the store terminal 30. At this time, the information on the home-stored product is transmitted from the user terminal 20 to the server 10. According to these configurations, even when the user makes a purchase at the store, it is possible to obtain the operation and effects that are the same as or similar to those of the information processing system 1 of the first embodiment.

### Other Embodiments

Although the above embodiments have described an example in which the method of determining the purchase price of a product in the information processing system according to these embodiments is applied to home storage, the purchase price determination method can also be applied to information processing systems other than home storage as described above. When the purchase price determination method is applied to the purchase of products at a store or conventional home delivery services, “home-stored products” in the above embodiments may be replaced with “products”. When it is applied to information processing systems other than home storage, the server 10 may not manage the purchase states of products (e.g., FIG. 6).

When the purchase price determination method is applied to those other than home storage, the server 10 has only to include at least: the storage unit 101 that stores information on a price of a product and stores a discount price lower than a regular price of the product in association with an applicable period during which the discount price is applied to the product; the receiving unit 103 that receives an instruction to purchase the product; the determination unit 105 that when at least a part of a predetermined period with reference to predetermined timing related to purchase of the product overlaps with the applicable period, determines a purchase price of the product at a lowest discount price applied to the overlapping applicable period; and the output unit 102 that outputs information on the purchase price determined by the determination unit 105.

It is sufficient that the price information for the selling price of a product stored in the storage unit 101 is information on the selling prices of the product at one or more stores. The stores can include, for example, a plurality of stores of particular companies that use the information processing system according to these embodiments and/or other companies that do not use the information processing system. Here, the particular companies are not limited to one company, but may be a plurality of companies that use the information processing system according to these embodiments. Note that the term “companies” in the particular companies and/or the other companies can also be replaced with supermarkets, online supermarkets, mass retailers, brands, or the like. By storing the price information for the selling prices of a product at a plurality of stores of the particular companies and/or the other companies, the storage unit 101 can provide the product to a user at a reasonable price including the particular companies and/or the other companies (e.g., cheaper than other stores) at the timing when the user needs it.

Specifically, the information processing apparatus 10 includes a collection unit (not shown) that collects price information for the prices of a product at a plurality of stores of the particular companies and/or the other companies, and the storage unit 101 may store the price information collected by the collection unit. The determination unit 105 may determine the purchase price of the product at the lowest price of the selling prices of the product at the particular companies and/or the other companies in a predetermined period with reference to the purchase timing of the product by referring to the storage unit 101.

The collection unit collects the price information for products at the particular companies and/or the other companies at a predetermined cycle (e.g., daily or weekly), and the storage unit 101 may store, for the same product, the price information at the particular companies, the price information for the product at the other companies, and an applicable period of the price (e.g., a date in the case of daily collection or a week in the case of weekly collection) in association with one another. If at least a part of a predetermined period with reference to the purchase timing of a product overlaps with the applicable period, the determination unit 105 may determine the purchase price of the product at the lowest price of the prices at the particular companies and/or the other companies that are applied to the overlapping applicable period.

In the above embodiments, an example has been described in which home-stored products are delivered to the home from a retail store using an existing home delivery route, but home-stored products may be delivered in any way. The store is not limited to an actual store. For example, an order may be received at a virtual store on an electronic commerce (EC) site, and the home-stored products may be delivered from a predetermined storage location (e.g., a warehouse) to the user's home.

The above embodiments have been described assuming that home delivery is to deliver products to a user's home or the like and home-stored products are delivered to the home by a store clerk or a home delivery person. However, home-stored products may be delivered by the user themselves, and the entity that delivers the home-stored products to the user is not questioned. That is, in these embodiments, the entity that makes a delivery and the destination of the product may or may not be the same. For example, “products delivered to a user with the purchase state set to the unpurchased state” are not limited to home-stored products in the unpurchased state carried by a clerk or a home delivery person to the user, but may include products that the user takes out of the store without checking out at the register, and that are carried by the user themselves to a predetermined location (e.g., inside the user's house or to a dedicated locker). When the user themselves carries the home-stored products in the unpurchased state from the store, the server 10 may register the home-stored products in the storage unit 101 based on an instruction from the user. As a result of the registration, information indicative of being the home-stored product (e.g., a home-stored product label in FIG. 1) may be output (e.g., printed out) to the user. For example, by the user attaching the printed home-stored product label to the home-stored product taken out by themselves, store clerks can distinguish between taking out a home-stored product and illegally taking out a product. The server 10 may use a camera that is installed, for example, in the store to detect products for which payment has not been made among the products that the user has taken out of the store, and register the detected products in the storage unit 101 as home-stored products.

In the above embodiments, it is assumed that the receiving unit 103 receives an instruction to purchase a home-stored product from a user, but there is no limitation to this. For example, the receiving unit 103 may receive an instruction to purchase a home-stored product from the store terminal 30 or may receive it from the management company.

In the above embodiments, the management unit 104 determines the price of the product based on the purchase date of the home-stored product for which the purchase instruction has been received, but there is no limitation to this. The management unit 104 may determine the price of the product based on the order date on which the order instruction has been received. The management unit 104 may determine the price of the product using a model based on machine learning. For example, the model may receive input of the product information for the product for which the purchase instruction has been received and at least one of the order date and the purchase date, and output the price of the product. The management unit 104 may grant points to the user when an instruction to purchase a home-stored product is received.

The users who can use the home storage described above may be limited to users registered in advance as members of the retail store. The users registered as members may be, for example, users whose monthly or annual purchase price at the retail store is greater than a predetermined amount or is greater than or equal to the predetermined amount. The management unit 104 may determine the price of the product for each user registered as a member. For example, the higher the monthly or annual purchase price of the user, the lower the price of the product may be determined.

An application for home storage may be installed on the user terminal 20 of a user who uses home storage. The functions of the user terminal 20 shown in FIG. 4 may be realized by the application.

The user terminal 20 may display information that allows the user to select either the home storage of products or the conventional home delivery service and receive input of the result of selection of the home storage or the home delivery service by the user. An order instruction received by the receiving unit 103 may include information indicating that home storage has been selected.

The purchase price of a home-stored product A may be determined at the lowest price within a predetermined period with reference to the purchase date of the product A (e.g., the past month). In this case, the purchase price of a product at the retail store generally changes depending on whether it is a special sale day, but in the case of home storage, the purchase price of a home-stored product is determined at the lowest price within a predetermined period with reference to the purchase date, and therefore the home-stored product can be purchased at a reasonable price regardless of the timing when the product is needed.

The purchase date that serves as a reference for the purchase price of the home-stored product A is, for example, the settlement date (e.g., the monthly settlement date) or the date on which the order instruction or the purchase instruction has been received, but without being limited to this, it may be any date related to the purchase or order of the home-stored product A.

The price information may be information indicating at least one of the regular price, a discount price, and the lowest price within the most recent predetermined period of the product.

The management unit 104 may determine the purchase price of a home-stored product for which the purchase instruction has been received by the receiving unit 103. Specifically, the management unit 104 may determine the price of the product at the lowest price within a predetermined period with reference to the purchase date of the home-stored product for which the purchase instruction has been received. Alternatively, the management unit 104 may determine the price of the product at the price on the purchase date of the home-stored product for which the purchase instruction has been received.

The server 10 may determine the price of the home-stored product at the lowest price within a predetermined period with reference to the purchase date of the home-stored product. The purchase date may be, for example, the settlement date of the product (e.g., the monthly settlement date), or the date when the purchase instruction was received.

As described above, in the predetermined embodiments of the present disclosure, products arrive at the home or the like even without paying money, and thereafter, payment processing is performed when a predetermined condition is satisfied. The embodiments described herein are for facilitating understanding of the present disclosure and are not for interpreting the present disclosure in a limited manner. Each element provided in the embodiments as well as its arrangement, material, condition, shape, size, and the like are not limited to those illustrated, but can be changed as appropriate. It is also possible to partially swap or combine the configurations shown in different embodiments.

What is claimed is:

1. An information processing system comprising:
a storage unit that stores a user's purchase state of a product; and
a management unit that manages the purchase state, and when information on the product for the user is read at a store, stores the purchase state of the product in the storage unit with the purchase state set to an unpurchased state,
wherein the management unit determines whether or not a first condition has been satisfied after the product has been set to the unpurchased state, and when it is determined that the first condition has been satisfied, updates the purchase state of the product stored in the storage unit from the unpurchased state to a purchased state.

2. The information processing system according to claim 1,
wherein the first condition includes that an order instruction of a product has been newly received from the user.

3. The information processing system according to claim 2,
wherein the first condition includes that the order instruction has been received for the same product as a product with the purchase state set to the unpurchased state.

4. The information processing system according to claim 1, wherein
the storage unit further stores information on a product time limit of the product, and
the first condition includes that a period until the product time limit of the product with the purchase state set to the unpurchased state satisfies a second condition.

5. The information processing system according to claim 1, wherein
the storage unit further stores purchase history information indicating products which have been purchased by the user before, and
the management unit determines a product that satisfies a predetermined matching condition from among the products included in the purchase history information as a product to be delivered to the user with the purchase state set to the unpurchased state.

6. The information processing system according to claim 5,
wherein the predetermined matching condition is a condition of being a product selected by the user from a plurality of products included in the purchase history information.

7. The information processing system according to claim 5,
wherein the predetermined matching condition is that the product has the highest priority when a plurality of products included in the purchase history information are sorted according to a predetermined sorting condition.

8. The information processing system according to claim 1,
wherein the management unit determines the same product as a product for which purchase registration has been performed by the user as a product to be delivered to the user with the purchase state set to the unpurchased state, regardless of whether or not an order instruction from the user has been received.

9. The information processing system according to claim 5, wherein
the purchase history information includes information on a purchase date of the product,
the storage unit further stores a model generated based on machine learning using purchase history information of each user and a product recommended for each user as learning data, and
the management unit determines a result when the purchase history information including the information on the purchase date of the user is input to the model as a product that satisfies the predetermined matching condition.

10. The information processing system according to claim 1, comprising:
a receiving unit that receives a purchase instruction of a product;
a determination unit that determines a purchase price of the product at a lowest selling price of the product in a predetermined period with reference to predetermined timing related to purchase of the product by referring to a first storage unit that stores information on a selling price of the product; and
an output unit that outputs information on the purchase price determined by the determination unit.

11. The information processing system according to claim 10,
wherein the predetermined timing is timing when the purchase instruction has been received by the receiving unit.

12. The information processing system according to claim 11,
wherein the predetermined timing is timing when payment processing is performed for the product for which the purchase instruction has been received by the receiving unit.

13. The information processing system according to claim 11,
wherein the predetermined timing is timing when an order instruction has been by the receiving unit or timing when the product has been delivered.

14. An information processing method wherein one or more information processing apparatuses perform:
a step of storing a user's purchase state of a product;
a step of, when information on the product for the user is read at a store, setting the purchase state of the product to an unpurchased state;
a step of determining whether or not a first condition has been satisfied after the product has been set to the unpurchased state; and
a step of, when it is determined that the first condition has been satisfied, updating the purchase state of the product from the unpurchased state to a purchased state.

15. A non-transitory computer-readable storage medium storing instructions which, when executed by a computing device, causing the computing device to function perform as:
a storage unit that stores a user's purchase state of a product; and
a management unit that manages the purchase state, and when information on the product for the user is read at a store, stores the purchase state of the product in the storage unit with the purchase state set to an unpurchased state,
wherein the management unit determines whether or not a first condition has been satisfied after the product has been set to the unpurchased state, and when it is determined that the first condition has been satisfied, updates the purchase state of the product stored in the storage unit from the unpurchased state to a purchased state.
